(19) United States
(12) Patent Application Publication
(10) Pub. No.: US 2025/0379497 A1
(43) Pub. Date: Dec. 11, 2025

(54) Power Transmission Device for an Electrical Machine, Having an Inductive Energization Device and a Free-Wheeling Circuit

(71) Applicant: Bayerische Motoren Werke Aktiengesellschaft, Muenchen (DE)

(72) Inventors: Zakaria El Khawly, Muenchen (DE); Said El-Barbari, Freising (DE)

(21) Appl. No.: 19/233,109

(22) Filed: Jun. 10, 2025

(30) Foreign Application Priority Data
Jun. 11, 2024 (DE) 10 2024 116 269.4

(51) Int. Cl. H02K 11/33; H02K 11/042

(52) U.S. Cl. CPC H02K 11/33; H02K 11/042; H02K 2213/06

(57) ABSTRACT

The disclosure relates to a power transmission device, including an inductive energization device for energizing a rotor winding of a rotor of the electrical machine and a free-wheeling circuit for reducing energy stored in the rotor winding during a malfunction. The energization device has a stationary primary side and a rotating secondary side. The primary side includes an inverter for connecting to a power supply device and supplying an AC current and a primary coil for the excitation of a magnetic field. The secondary side includes a secondary coil permeable by the magnetic field and a rectifier for electrically connecting to the rotor winding and rectifying the AC current induced by the magnetic field in the secondary coil. The free-wheeling circuit is configured to isolate the secondary side from the rotor winding during a malfunction and establish a conductive electrical connection between the rotor winding and the primary side.

### CROSS REFERENCE TO RELATED APPLICATION

This application claims priority under 35 U.S.C. § 119 from German Patent Application No. 10 2024 116 269.4, filed Jun. 11, 2024, the entire disclosure of which is herein expressly incorporated by reference.

### BACKGROUND AND SUMMARY

The present disclosure relates to a power transmission device for an externally excited electrical machine, having an inductive energization device for energizing a rotor winding of a rotor of the electrical machine. The energization device comprises a stationary primary side and a rotating secondary side, which rotation is executed by the fastening thereof to the rotor, wherein the primary side comprises an inverter for connecting to a power supply device and for supplying an AC current, and a primary coil which is connected to the inverter for the excitation of a primary-side magnetic field by the AC current, and wherein the secondary side comprises a secondary coil which is permeable by the primary-side magnetic field, and a rectifier, which is connected to the secondary coil, for electrically connecting to the rotor winding and for the rectification of the AC current which is induced by the magnetic field in the secondary coil, for the rotor winding. The present disclosure moreover relates to an externally excited electrical machine and to an electric drive unit.

Current-excited or externally excited electrical machines can be employed as drive machines for electrified motor vehicles. Current-excited electrical machines of this type customarily comprise a stator, having energizable stator windings, and a rotor which is rotatably mounted vis-à-vis the stator, having a rotor body and an energizable rotor winding which is supported by the rotor body. For the energization of the rotor winding, the electrical machine customarily comprises a power transmission device. The power transmission device can be designed for conductive power transmission, for example by a slipring module which is fastened to a rotor shaft of the motor and a brush module which is stationarily mounted vis-à-vis the rotor, or for inductive or contactless power transmission. An inductive energization device customarily comprises a stationarily mounted primary side, and a secondary side which rotates with the rotor. A primary-side magnetic field which is excited in a primary coil of the primary side permeates a secondary coil of the secondary side, and induces an AC current herein, which is converted by a secondary-side rectifier into a DC current for the rotor winding.

An inductive energization device of this type, in comparison with a conductive energization device, is configured with a low-wear design. An inductive energization device, moreover, occupies a smaller structural space than a conductive energization device. However, as a result of the permanent connection between the secondary side and the rotor winding, which short-circuits the rotor winding, in the event of a malfunction of the electrical machine, conversely to a conductive energization device, no free-wheeling operation can be established, by which energy in rotor can be rapidly and securely reduced by the re-injection thereof into the primary side.

An object of the present disclosure is the provision of a solution, by which a free-wheeling operation of an electrical machine having inductive power transmission can be provided.

According to aspects of the present disclosure, this object is fulfilled by a power transmission device, by an externally excited electrical machine, and by an electric drive having the features disclosed herein. Advantageous embodiments are also disclosed in the description and the figures.

The power transmission device according to the present disclosure for an externally excited electrical machine comprises an inductive energization device for energizing a rotor winding of a rotor of the electrical machine. The energization device comprises a stationary primary side and a rotating secondary side, which rotation is executed by the fastening thereof to the rotor, wherein the primary side comprises an inverter for connecting to a power supply device and for supplying an AC current, and a primary coil which is connected to the inverter for the excitation of a primary-side magnetic field by the AC current, and wherein the secondary side comprises a secondary coil which is permeable by the primary-side magnetic field, and a rectifier, which is connected to the secondary coil, for electrically connecting to the rotor winding and for the rectification of the AC current which is induced by the magnetic field in the secondary coil, for the rotor winding. The energization device moreover comprises a free-wheeling circuit which, in the event of a malfunction, for the reduction of energy stored in the rotor winding, is designed to isolate the secondary side from the rotor winding, and to establish a conductive electrical connection between the rotor winding and the primary side, for the re-injection of energy which is stored in the rotor into the primary side.

The present disclosure moreover relates to an externally excited electrical machine comprising a stator, a rotor which is rotatably mounted vis-à-vis the stator, having an energizable rotor winding, and a power transmission device according to the present disclosure, wherein the secondary side is fastened to a rotor shaft of the rotor, and the secondary-side rectifier is electrically connected to the rotor winding. The electrical machine, which is configured as a current-excited synchronous machine (SSM), in particular, is an internal rotor machine, in which the rotor is rotatably mounted within a hollow cylindrical stator body of the stator. An electric drive unit for a motor vehicle according to the present disclosure comprises a traction battery, a power electronics module which is connected to the traction battery, and an externally excited electrical machine according to the present disclosure, which functions as a drive machine and is electrically connected to the power electronics module, wherein the primary side of the energization device is integrated in the power electronics module, and the power supply device for the primary side is configured by the traction battery.

The energization device is employed for feeding a current to the rotor winding of the rotor, for the excitation of a magnetic field. The primary side and secondary side are arranged with a mutual spacing, preferably a radial spacing, such that power can be transmitted by the primary side and the secondary side in a contactless or non-contact arrangement. The primary coil of the primary side can be arranged, for example, on the stator or on a housing component of the externally excited electrical machine. The primary coil can comprise a primary-side annular magnetic core, in particular a ferrite core, which carries primary-side winding conductors of the primary coil. The secondary coil is arranged on the rotor, in particular on the rotor shaft. The secondary coil, in particular, is arranged radially within the primary coil. The secondary coil can comprise a secondary-side annular magnetic core, in particular a ferrite core, which is fastened to the rotor shaft and which carries secondary-side winding conductors of the secondary coil.

For the transmission of power, the primary-side inverter converts a DC current which is supplied by the power supply device into an AC current, and feeds the latter to the primary coil. In this primary coil, a magnetic field is then excited, which permeates the secondary coil. In the secondary coil, an AC current is then induced, which current is fed to the secondary-side rectifier. The latter feeds the rectified AC current to the rotor winding. To this end, the secondary side comprises two output terminals, which are electrically connected to terminals of the rotor winding. For example, a first output terminal of the secondary side can be connected to a positive terminal of the rotor winding, and a second output terminal of the secondary side can be electrically connected to a negative terminal of the rotor winding.

In the event of a malfunction, for example in the event of a motor vehicle accident, it is necessary for the electrical machine to assume a safe state. Conversely to a permanently-excited electrical machine, an externally excited electrical machine provides an advantage, in that this state can be introduced by a free-wheeling operation, in which energy which is stored in the rotor can be rapidly and reliably reduced. For an inductive energization device, however, the rotor winding is permanently connected to the secondary side, such that the rotor winding, in the event of a malfunction, is short-circuited by the secondary side and, as a result, no re-injection of energy into the primary side, and thus no rapid reduction of energy, is enabled.

In order to enable the provision of the advantages of the inductive energization device with respect to low wear and limited space requirements, whilst enabling free-wheeling operation, the power transmission device comprises a free-wheeling circuit. In the event of a malfunction, this interrupts the short-circuit connection between the rotor winding and the secondary side, and moreover establishes the conductive connection between the rotor winding and the primary side. To this end, the free-wheeling circuit establishes a conductive, current conductor-based connection between the output terminals of the secondary side and the primary side. In particular, the free-wheeling circuit is configured to establish electrical contact with an output side of the primary-side inverter which is connected to the primary coil. The conductive connection is not permanent, but is provided in a temporary manner only, in the event of a malfunction. Thus, excepting a malfunction, in normal operation of the electrical machine, no conductive electrical coupling is in place, but only an inductive coupling between the rotor winding and the primary side. In the event of a malfunction, energy which is stored in the rotor is transmitted via the conductive connection to the primary side, where the rapid and reliable reduction thereof, for example by the injection thereof into the primary-side power supply device, is enabled. By the free-wheeling circuit, free-wheeling operation of the electrical machine can thus be provided, even for inductive power transmission.

It can be provided that the free-wheeling circuit comprises a first switching device which, on the output side, is connected to the secondary-side rectifier, and which establishes an electrical connection between the rectifier and at least one secondary-side output terminal, which is connectable to the rotor winding, except in the event of a malfunction, which electrical connection is interrupted in the event of a malfunction. The first switching device is preferably an electronic switching device, and comprises a semiconductor switch, in particular a transistor, which is connected to a secondary-side output terminal. The semiconductor switch can be connected, for example, between an output-side terminal of the rectifier and one of the secondary-side output terminals. In the normal operation of the electrical machine, excepting a malfunction, the first switching device assumes a closed position, wherein the semiconductor switch is set to a conducting state. In the event of a malfunction, the first switching device executes a switchover to an open position, wherein the semiconductor switch is set to a non-conducting state, for example by a control apparatus of the electric drive unit, as a result of which the secondary-side output terminal, and thus a terminal of the rotor winding, is separated from the rectifier. The electrical connection between the rotor winding and the secondary side is interrupted accordingly.

According to a further development of the present disclosure, the free-wheeling circuit comprises a second switching device, which is configured as an electromechanical switching device, a first switching contact unit, which is arranged on the primary side and is electrically connected to the primary side, and a second switching contact unit, which is arranged on the secondary side and is connected to secondary-side output terminals, wherein the switching contact units, excepting a malfunction, are arranged with a mutual clearance and, in the event of a malfunction, are in contact. The first switching contact unit, for example, is permanently connected to the output-side terminals of the primary-side inverter. The second switching contact unit is permanently connected to the secondary-side output terminals, and thus to the terminals of the rotor winding. The second switching contact unit rotates with the rotor, and is thus rotatably mounted vis-à-vis the stationary first switching contact unit. For example, the switching contact units can be arranged radially in relation to one another. The first and second switching contact units, excepting a malfunction, are not in contact, and are thus galvanically isolated. In the event of a malfunction, one of the switching contact units is moved in the direction of the other switching contact unit, until a contact is established therebetween and an electrical connection is formed. In particular, in the event of a malfunction, the switching contact units form a sliding contact.

It can be provided that the first switching contact unit comprises two first switching contacts, and the second switching contact unit comprises two second switching contacts, each connected to a secondary-side output terminal, wherein the two first switching contacts are moveable in the direction of the two second switching contacts. For example, the first switching contacts are configured as displaceable brush elements, each of which is electrically connected to one primary-side terminal, and the second switching contacts are configured as sliprings, which are respectively connected to the secondary-side output terminals by a connecting line. Excepting a malfunction, brush elements assume a first position, in which they are arranged with a clearance vis-à-vis the sliprings, such that no conductive electrical connection is in place between the rotor winding and the primary side. In the event of a malfunction, the brush elements execute a transfer from the first position to a second position, in which they engage with a surface of the sliprings and, accordingly, a conductive electrical connection in the form of a sliding contact or wiper contact is temporarily provided. As the sliding contact is only temporarily in place, for the execution of free-wheeling operation, it is not necessary for the brushes, such as in a conductive energization device having a permanent sliding contact, to be configured as carbon brushes of graphite construction. Such brushes, conversely, can be formed of a cost-effective material, for example copper.

It has proved to be advantageous if the first switching contact is integrated in a magnetic core of the primary coil, and the second switching contact is attachable to a rotor shaft of the rotor, wherein the magnetic core of the primary coil radially encloses the rotor shaft, and wherein the first switching contact can be led out of the magnetic core of the primary coil in a radial direction. For example, the magnetic core of the primary coil can comprise location openings for the first contact elements, wherein the first contact elements, excepting a malfunction, are arranged in the location openings and, in the event of a malfunction, are at least partially arranged outside the location openings. The magnetic core of the secondary coil is arranged on the rotor shaft, in axial proximity to the second switching contact elements of the second switching contact unit. As a result, connecting lines which are electrically connected to the second switching contacts can be arranged within the rotor shaft, which is configured as a hollow shaft and led out from thence to the terminals of the rotor winding. By the integration of the first switching contact unit in the magnetic core of the primary coil, the free-wheeling circuit can be configured in a particularly space-saving manner.

The embodiments presented with respect to the power transmission device according to the present disclosure, and the advantages thereof, apply in a corresponding manner to the externally excited electrical machine and the electric drive unit disclosed herein.

Further features of the present disclosure proceed from the figures and the description of the figures. Features and combinations of features specified in the preceding description, and features and combinations of features specified hereinafter in the description of the figures and/or represented in the figures alone, are not only applicable in the respectively indicated combination, but also in other combinations, or in isolation.

Aspects of the present disclosure are described in greater detail hereinafter with respect to a preferred exemplary embodiment, and with reference to the drawings.

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1 shows a circuit diagram of a power transmission device for an electrical machine, in a normal operation of the electrical machine;

FIG. 2 shows the circuit diagram of the power transmission device in the event of a malfunction of the electrical machine; and

FIG. 3 shows a schematic representation of a section of the power transmission device, and of a rotor shaft of a rotor of the electrical machine.

### DETAILED DESCRIPTION OF THE DRAWINGS

In the figures, identical and functionally equivalent elements are identified by the same reference symbols.

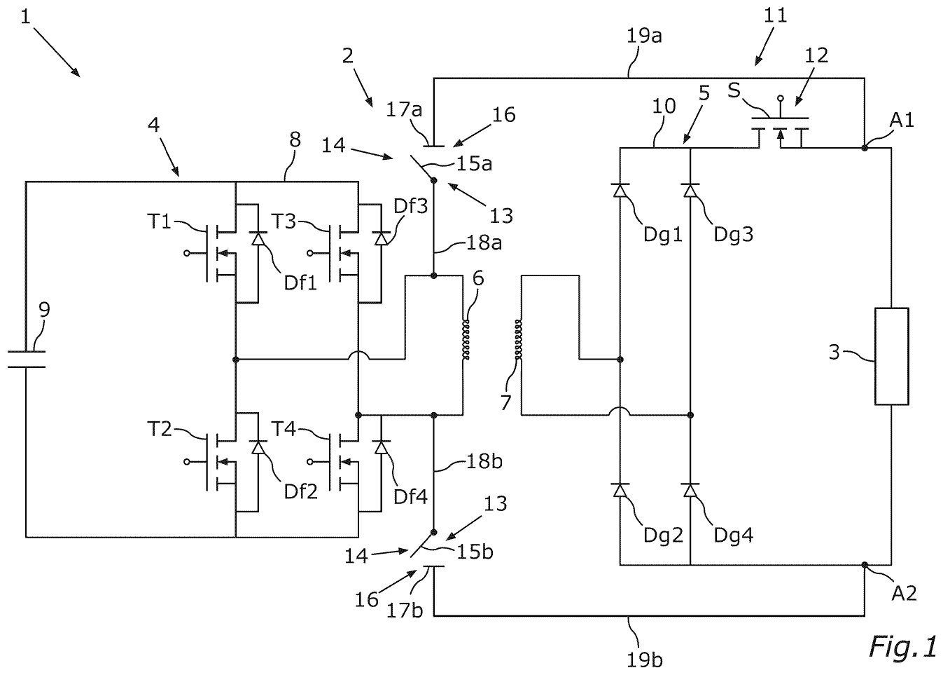

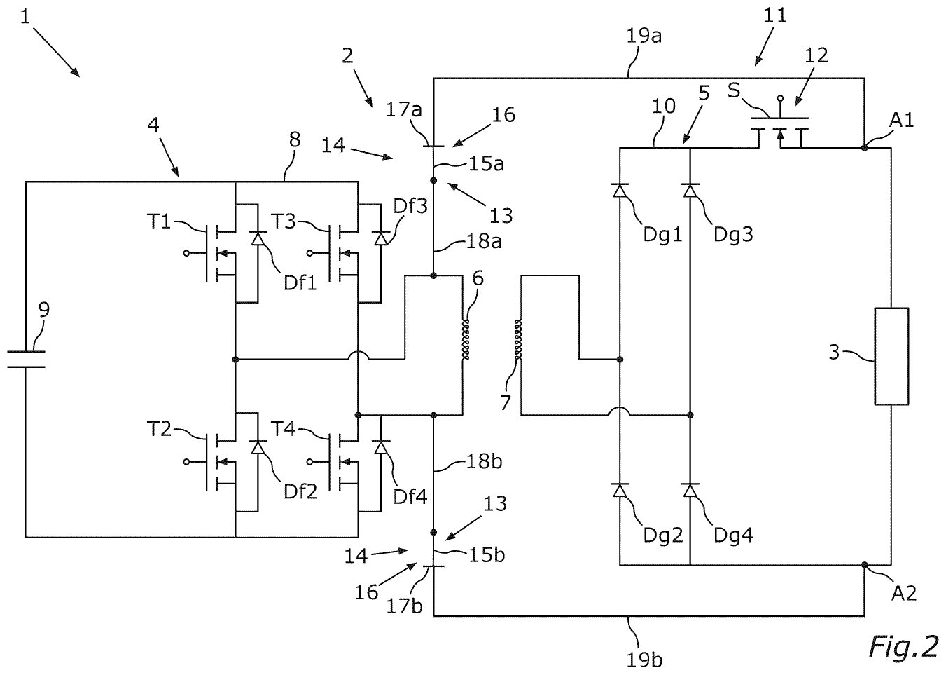

FIG. 1 and FIG. 2 show a circuit diagram of a power transmission device 1 for an electrical machine. The electrical machine can be employed as a drive machine for an electrified motor vehicle. The power transmission device 1 comprises an inductive energization device 2, which is designed to transmit energy from an unrepresented power supply device, for example a traction battery of the motor vehicle, to a rotor winding 3 of a rotor of the electrical machine, for the excitation of a magnetic motor flux. To this end, the energization device 2 comprises a primary side 4, which is stationarily mounted, and which is electrically connected to the power supply device, and a secondary side 5 which is rotatably mounted, and which is electrically connected to the rotor winding 3 of the rotor. For example, the primary side 4 is fastened to a stator or to a housing of the electrical machine, whereas the secondary side 5 is fastened to the rotor, and thus rotates with the rotor.

For inductive electrical coupling, the primary side 4 comprises a primary coil 6, and the secondary side comprises a secondary coil 7. These coils 6, 7 are configured in a contactless arrangement in relation to one another, but with a clearance, in which a magnetic field of the primary coil 6 can permeate the secondary coil 7. The primary side 4 moreover comprises an inverter 8, which is electrically connected to the power supply device via an intermediate circuit capacitor 9. The inverter 8 is configured as a four-quadrant controller, having four semiconductor switches T1, T2, T3, T4 which are arranged in an H-bridge circuit, each of which comprises a reverse-polarity free-wheeling diode Df1, Df2, Df3, Df4. The inverter 8 converts the DC current which is supplied by the power supply device into an AC current, which is fed to the primary coil 6 for the excitation of the primary-side magnetic field.

The primary-side magnetic field permeates the secondary coil 7, in which an AC current is then induced. The latter is rectified by a rectifier 10 on the secondary side 5, and is supplied to output terminals A1, A2 on the secondary side 5, which are electrically connected to the rotor winding 3. The rectifier 10 is configured as a bridge rectifier, and comprises four rectifier diodes Dg1, Dg2, Dg3, Dg4.

In the event of a malfunction of the electrical machine, it is intended that the latter should execute a transition to a safe state. To this end, inter alia, energy which is stored in the rotor winding 3 is reduced. In order to enable the reliable reduction of energy within a short time, it is desirable that this energy, for example by a free-wheeling operation of the rotor, can be fed back into the power supply device. As a result of the inductive coupling between the rotor winding 3 and the power supply device, a free-wheeling operation by the energization device 2 is not possible, as the secondary side 5 would short-circuit the rotor winding 3. Consequently, the power supply device 1, additionally to the inductive energization device 2, comprises a free-wheeling circuit 11, which can establish a conductive coupling between the rotor winding 3 and the power supply device and which, additionally, can interrupt the electrical connection between the rotor winding 3 and the secondary side 5.

To this end, the free-wheeling circuit 11 comprises an electronic switching device 12 and an electromechanical switching device 13. The first switching device 12 comprises a semiconductor switch S, which is connected between an output-side terminal of the rectifier 10 and the output terminal A1. The electromechanical switching device 13 comprises a first switching contact unit 14, which is arranged on the primary side, having two first switching contacts 15a, 15b, and a second switching contact unit 16, which is arranged on the secondary side, having two second switching contacts 17a, 17b. The switching contact 15a is electrically connected by a connecting line 18a to a first output-side terminal of the inverter 8, and the switching contact 15b is electrically connected by a second connecting line 18b to a second output-side terminal of the inverter 8. The switching contact 17a is electrically connected by a connecting line 19a to the first output terminal A1 on the secondary side 5, and the switching contact 17b is electrically connected by a connecting line 19b to the second output terminal A2 on the secondary side 5.

In FIG. 1, the power transmission device 1 is represented in a normal operation of the electrical machine, in the absence of a malfunction. The semiconductor switch S which, in particular, is configured as a depletion-mode MOSFET, assumes a conducting state, as a result of which the electronic switching device 12 is closed, and establishes an electrical connection between the secondary side 5 and the rotor winding 3, by which the rotor winding 3 is energized. The electromechanical switching device 13 moreover assumes an open position, in which the switching contacts 15a, 15b are galvanically isolated from the switching contacts 17a, 17b. Accordingly, the primary side 4 and the secondary side 5 and, as a result, the rotor winding 3 and the power supply device, are also galvanically isolated.

In FIG. 2, the power transmission device 1 is represented in the event of a malfunction. The semiconductor switch S assumes a non-conducting state, as a result of which the electronic switching device 12 is open, and thus interrupts the electrical connection between the secondary side 5 and the rotor winding 3. Moreover, the electromechanical switching device 13 assumes a closed position, in which the switching contacts 15a, 15b are contact-connected with the switching contacts 17a, 17b, and a conductive electrical connection is thus established between the rotor winding 3 and the primary side 4.

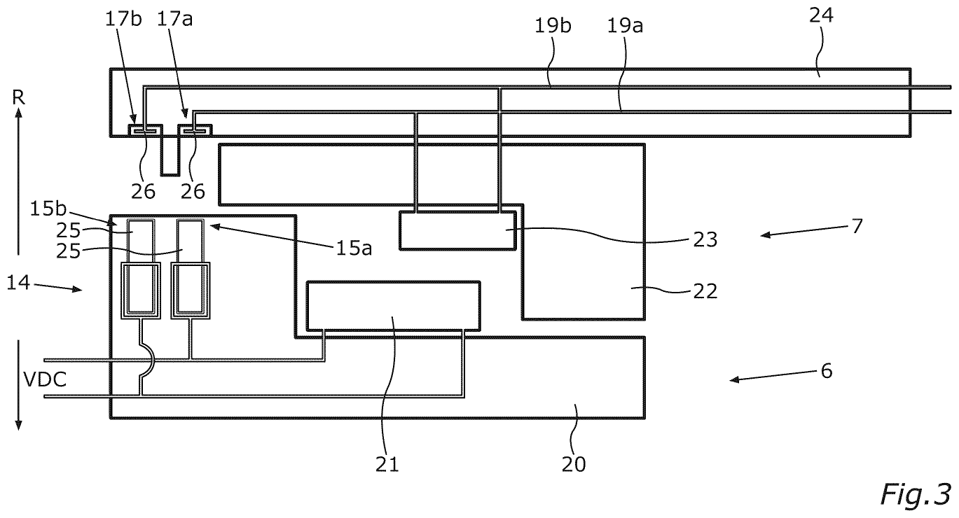

FIG. 3 shows a schematic representation of a section of the power transmission device 1. Herein, the primary coil 6 and the secondary coil 7 are represented, which are arranged adjacently to one another in the radial direction R. The primary coil 6 comprises a primary-side magnetic core 20, which carries primary-side winding conductors 21 of the primary coil 6. The winding conductors 21 are connected via the unrepresented inverter 8 to the supply voltage VDC of the power supply device. The secondary coil 7 comprises a secondary-side magnetic core 22, which carries secondary-side winding conductors 23. The secondary-side magnetic core 22 is connected to a rotor shaft 24 of the rotor in a rotationally fixed manner.

The first switching contacts 15a, 15b of the first switching contact unit 14 are integrated in the primary-side magnetic core 20. For example, the first switching contacts 15a, 15b can comprise brush elements 25, which can be led out of the primary-side magnetic core 20 in a radial direction. The second switching contacts 17a, 17b are fastened to the rotor shaft 24 and can comprise, for example, sliprings 26. The connecting lines 19a, 19b, which are electrically connected to the second switching contacts 17a, 17b, are integrated in the rotor shaft 24 and connected to the output terminals A1, A2. Excepting a malfunction, the brush elements 25 are countersunk in the magnetic core 20. In the event of a malfunction, the brush elements 25 are arranged at least partially externally to the magnetic core 20, and engage with the sliprings 26 to form a sliding contact. As the conductive electrical connection which is configured by the brush elements 25 and the sliprings 26 is only present in the event of a malfunction, this connection can be designed in a simple and compact manner, for short-term employment only.

The foregoing disclosure has been set forth merely to illustrate example embodiments and is not intended to be limiting. Since modifications of the disclosed embodiments incorporating the spirit and substance of the present disclosure may occur to persons skilled in the art, the disclosure should be construed to include everything within the scope of the present disclosure and equivalents thereof.

What is claimed is:

1. A power transmission device for an externally excited electrical machine, comprising:
an inductive energization device configured to energize a rotor winding of a rotor of the externally excited electrical machine, the inductive energization device having a stationary primary side and a rotating secondary side, rotation of the secondary side being executed by a fastening thereof to the rotor, wherein:
the primary side comprises:
an inverter configured to connect to a power supply device and supply an AC current, and
a primary coil connected to the inverter and configured to excite a primary-side magnetic field by the AC current, and
the secondary side comprises:
a secondary coil permeable by the primary-side magnetic field, and
a rectifier connected to the secondary coil and configured to electrically connect to the rotor winding and rectify the AC current induced by the primary-side magnetic field in the secondary coil for the rotor winding; and
a free-wheeling circuit configured to, during a malfunction:
reduce energy stored in the rotor winding,
isolate the secondary side from the rotor winding, and
establish a conductive electrical connection between the rotor winding and the primary side for re-injection of energy stored in the rotor into the primary side.

2. The power transmission device according to claim 1, wherein:
the free-wheeling circuit comprises a first switching device connected, on an output side, to the rectifier of the secondary side and configured to establish an electrical connection between the rectifier and at least one output terminal of the secondary side; and
the at least one output terminal is connectable to the rotor winding except during a malfunction, wherein the electrical connection is configured to be interrupted during the malfunction.

3. The power transmission device according to claim 2, wherein:
the first switching device is an electronic switching device comprising a semiconductor switch connected to an output terminal of the secondary side.

4. The power transmission device according to claim 1, wherein:
the free-wheeling circuit is configured to establish a conductive electrical contact with an output side of the inverter connected to the primary coil.

5. The power transmission device according to claim 1, wherein the free-wheeling circuit comprises:
a second switching device configured as an electromechanical switching device;
a first switching contact unit arranged on the primary side; and
a second switching contact unit arranged on the secondary side and connected to output terminals of the secondary side,
wherein the first switching contact unit and the second switching contact unit are arranged with a mutual clearance in an absence of a malfunction and are in contact during a malfunction.

6. The power transmission device according to claim 5, wherein:
the first switching contact unit and the second switching contact unit form a sliding contact during the malfunction.

7. The power transmission device according to claim 5, wherein:
the first switching contact unit comprises two first switching contacts; and
the second switching contact unit comprises two second switching contacts each connected to an output terminal of the secondary side,
wherein the two first switching contacts are moveable in a direction of the two second switching contacts.

8. The power transmission device according to claim 7, wherein:
the first switching contacts are integrated in a magnetic core of the primary coil;
the second switching contacts are attachable to a rotor shaft of the rotor;
the magnetic core of the primary coil encloses the rotor shaft radially; and
the first switching contacts are configured to be led out of the magnetic core of the primary coil in a radial direction.

9. The power transmission device according to claim 7, wherein:
the first switching contacts comprise displaceable brush elements electrically connected to terminals of the primary side; and
the second switching contacts comprise sliprings respectively connected by a connecting line to each respective output terminal of the secondary side.

10. An externally excited electrical machine, comprising:
a stator; and
a rotor rotatably mounted vis-à-vis the stator and having an energizable rotor winding; and
a power transmission device comprising:
an inductive energization device configured to energize a rotor winding of the rotor, the inductive energization device having a stationary primary side and a rotating secondary side, rotation of the secondary side being executed by a fastening thereof to the rotor, wherein:
the primary side comprises: an inverter configured to connect to a power supply device and supply an AC current, and a primary coil connected to the inverter and configured to excite a primary-side magnetic field by the AC current, and
the secondary side comprises: a secondary coil permeable by the primary-side magnetic field, and a rectifier connected to the secondary coil and configured to electrically connect to the rotor winding and rectify the AC current induced by the primary-side magnetic field in the secondary coil for the rotor winding, wherein the secondary side is fastened to a rotor shaft of the rotor, and the rectifier of the secondary side is electrically connected to the rotor winding; and
a free-wheeling circuit configured to, during a malfunction: reduce energy stored in the rotor winding, isolate the secondary side from the rotor winding, and establish a conductive electrical connection between the rotor winding and the primary side for re-injection of energy which is stored in the rotor into the primary side.

11. The externally excited electrical machine according to claim 10, wherein:
the free-wheeling circuit comprises a first switching device connected, on an output side, to the rectifier of the secondary side and configured to establish an electrical connection between the rectifier and at least one output terminal of the secondary side; and
the at least one output terminal is connectable to the rotor winding except during a malfunction, wherein the electrical connection is configured to be interrupted during the malfunction.

12. The externally excited electrical machine according to claim 11, wherein:
the first switching device is an electronic switching device comprising a semiconductor switch connected to an output terminal of the secondary side.

13. The externally excited electrical machine according to claim 10, wherein:
the free-wheeling circuit is configured to establish a conductive electrical contact with an output side of the inverter connected to the primary coil.

14. The externally excited electrical machine according to claim 10, wherein the free-wheeling circuit comprises:
a second switching device configured as an electromechanical switching device;
a first switching contact unit arranged on the primary side; and
a second switching contact unit arranged on the secondary side and connected to output terminals of the secondary side,
wherein the first switching contact unit and the second switching contact unit are arranged with a mutual clearance in an absence of a malfunction and are in contact during a malfunction.

15. The externally excited electrical machine according to claim 14, wherein:
the first switching contact unit and the second switching contact unit form a sliding contact during the malfunction.

16. The externally excited electrical machine according to claim 14, wherein:
the first switching contact unit comprises two first switching contacts; and
the second switching contact unit comprises two second switching contacts each connected to an output terminal of the secondary side,
wherein the two first switching contacts are moveable in a direction of the two second switching contacts.

17. The externally excited electrical machine according to claim 16, wherein:
the first switching contacts are integrated in a magnetic core of the primary coil;
the second switching contacts are attachable to the rotor shaft of the rotor;
the magnetic core of the primary coil encloses the rotor shaft radially; and
the first switching contacts are configured to be led out of the magnetic core of the primary coil in a radial direction.

18. The externally excited electrical machine according to claim 16, wherein:
the first switching contacts comprise displaceable brush elements electrically connected to terminals of the primary side; and
the second switching contacts comprise sliprings respectively connected by a connecting line to each respective output terminal of the secondary side.

19. A drive unit for a motor vehicle, comprising:
a traction battery,
a power electronics module connected to the traction battery, and
an externally excited electrical machine electrically connected to the power electronics module, comprising:
a stator; and
a rotor rotatably mounted vis-à-vis the stator and having an energizable rotor winding; and
a power transmission device comprising:
an inductive energization device configured to energize a rotor winding of the rotor, the inductive energization device having a stationary primary side and a rotating secondary side, rotation of the secondary side being executed by a fastening thereof to the rotor, wherein:
the primary side comprises: an inverter configured to connect to a power supply device and supply an AC current, and a primary coil connected to the inverter and configured to excite a primary-side magnetic field by the AC current, wherein the primary side is integrated in the power electronics module and the power supply device is configured by the traction battery,
the secondary side comprises: a secondary coil permeable by the primary-side magnetic field, and a rectifier connected to the secondary coil and configured to electrically connect to the rotor winding and rectify the AC current induced by the primary-side magnetic field in the secondary coil for the rotor winding, wherein the secondary side is fastened to a rotor shaft of the rotor, and the rectifier of the secondary side is electrically connected to the rotor winding; and
a free-wheeling circuit configured to, during a malfunction: reduce energy stored in the rotor winding, isolate the secondary side from the rotor winding, and establish a conductive electrical connection between the rotor winding and the primary side for re-injection of energy which is stored in the rotor into the primary side.

20. The drive unit according to claim 19, wherein:
the free-wheeling circuit comprises a first switching device connected, on an output side, to the rectifier of the secondary side and configured to establish an electrical connection between the rectifier and at least one output terminal of the secondary side; and
the at least one output terminal is connectable to the rotor winding except during a malfunction, wherein the electrical connection is configured to be interrupted during the malfunction.
